(19) United States
(12) Patent Application Publication
(10) Pub. No.: US 2013/0030811 A1
(43) Pub. Date: Jan. 31, 2013

(54) NATURAL QUERY INTERFACE FOR CONNECTED CAR

(71) Applicants: Jules Olleon, Sunnyvale, CA (US); Rohit Talati, Santa Clara, CA (US); David Kryze, Campbell, CA (US); Akihiko Sugiura, Los Altos, CA (US)

(72) Inventors: Jules Olleon, Sunnyvale, CA (US); Rohit Talati, Santa Clara, CA (US); David Kryze, Campbell, CA (US); Akihiko Sugiura, Los Altos, CA (US)

(73) Assignee: PANASONIC CORPORATION, Osaka (JP)

(21) Appl. No.: 13/193,986

(22) Filed: Jul. 29, 2011

(51) Int. Cl. G10L 21/00; H04N 7/18; G10L 13/04

(52) U.S. Cl. 704/267; 704/275; 348/148; 348/E07.085; 704/E21.001; 704/E13.008

(57) ABSTRACT

Sensors within the vehicle monitor driver movement, such as face and head movement to ascertain the direction a driver is looking, and gestural movement to ascertain what the driver may be pointing at. This information is combined with video camera data taken of the external vehicle surroundings. The apparatus uses these data to assist the speech dialogue processor to disambiguate phrases uttered by the driver. The apparatus can issue informative responses or control vehicular functions based on queries automatically generated based on the disambiguated phrases.

### BACKGROUND OF THE INVENTION

The present disclosure relates to a dialogue system suitable for use in vehicles. More particularly, the disclosure relates to a computer-implemented natural language query system that resolves ambiguity using driver data, such as head or face position, eye gaze, hand and arm posture and gestures and other orientation data sensed by internal sensors, and correlates that driver data with external data, such as image data, sound data, and 3D depth data obtained external to the vehicle, such as.

Speech-enabled dialogue systems for use within vehicles present unique problems. Road noise within the vehicle cabin can significantly degrade speech recognition capabilities. In the past, this difficulty has been addressed by restricting the recognition system vocabulary and by using other recognition model training techniques that attempt to deal with the undesirably high degree of variability in signal-to-noise ratio and the resultant variability in recognition likelihood scores. In the instances where the recognizer fails, the conventional approach has been to use a dialogue system that will prompt the user to repeat the utterance that was not understood.

### SUMMARY

The present solution to the aforementioned problem takes a much different approach. The system uses sensors disposed inside the vehicle that are positioned to monitor physical activity of the driver, such as by monitoring the position and orientation of the driver's head or face. From this information, the system derives driver activity data that are stored as a function of time. In addition, a camera system disposed on the vehicle is positioned to collect visual data regarding conditions external to the vehicle as a function of time. A correlation processor associates non-transitory computer-readable memory time-correlated driver activity data with the visual data, and also optionally with location data from a cellular system or GPS system.

A disambiguation processor, operating in conjunction with the speech recognition processor, uses the time-correlated driver activity data, visual data and optional location data to ascertain from the driver activity what external condition the driver is referring to during an utterance. The disambiguation processor formulates a computer system query to correspond to the ascertained external condition.

The natural query processing apparatus is thus able to infer what the driver was looking at when the utterance was made, or to infer from other gestures performed by the driver during the utterance, to “fill in the gaps” or disambiguate the driver's utterance so that it can be used to generate a computer system query. The apparatus will thus address disambiguation issues caused by poor recognition. However, the apparatus has uses beyond dealing with cabin noise-induced recognition problems. The apparatus can formulate queries that would respond to driver utterances such as, “What is the name of that restaurant?” or “What did that sign say?” In both of these examples, a conventional recognition system, even one that perfectly recognized the words of the utterance, would not be able to generate a computer system query because it would have no way to know what restaurant the driver was referring to or what sign the driver was able to read.

### BRIEF DESCRIPTION OF THE DRAWINGS

FIG. 1 is a perspective view from within the cabin of the vehicle, illustrating some of the components of the natural query processing apparatus;

FIG. 2 is a hardware block diagram of the natural query processing apparatus;

FIG. 3 is a system block diagram illustrating one embodiment of the query processing apparatus;

FIG. 4 is a process flow diagram useful in understanding how the head or face position and orientation information is extracted;

FIG. 5 is a flow diagram illustrating the basic processing steps performed by the query processing apparatus;

FIGS. 6a and 6b are a detailed flow chart illustrating the disambiguation process;

FIG. 7 is a first use case diagram illustrating one exemplary use of the query processing apparatus;

FIG. 8 is a second use case diagram illustrating another exemplary use of the query processing apparatus; and

FIG. 9 is a system component diagram of one embodiment of the query processing apparatus.

### DESCRIPTION OF THE PREFERRED EMBODIMENTS

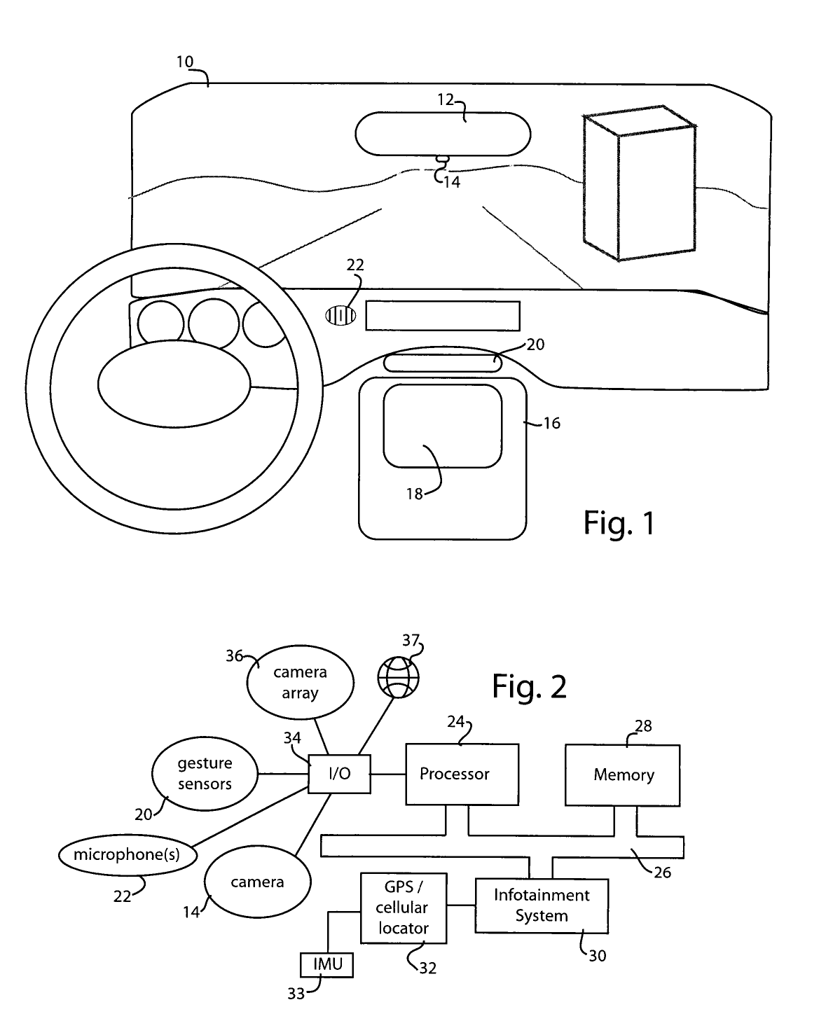

Referring to FIG. 1, the natural query processing apparatus will be described in the environment of an automotive vehicle. Of course, it will be appreciated that the query processing apparatus can be used in other types of vehicles as well. Referring to FIG. 1, the windshield 10 of an automotive vehicle provides a view of the road and surrounding environment as will be familiar. Attached in a suitable location such as beneath rearview mirror 12 is a camera 14, such as a visible light camera or 3D camera, that is positioned to monitor physical activity of the driver, such as the movement of the driver's face or head. Multiple cameras can also be used, to help see more of the environment and to help reconstruct depth information. The vehicle cabin may be equipped with a vehicle infotainment center 16 which may include a navigation system 18, which provides a display screen on which driver information can be displayed. The camera or cameras can be used to perform gesture sensing as well as monitoring the driver's head movement and eye gaze. If desired, the apparatus may also optionally include a gesture sensor array 20 that is positioned to detect physical gestures, such as hand gestures or arm movements made by the driver as in the act of pointing to a particular object outside the vehicle or pointing in a general direction. Preferably the gesture sensor should see gestures made on the sides of the vehicle; therefore the gesture sensor is designed to have a wide field of view. Alternatively, multiple gesture sensors can be deployed at different positions within the vehicle.

The query processing apparatus has as one of its components a speech processor to perform speech recognition upon utterances made within the vehicle. Thus, a suitable microphone 22 is positioned within the vehicle cabin so that it can pick up utterances made by the driver. The speech processing system may also include a speech synthesis or digitized speech playback system that issues audible information to the vehicle occupants through a suitable audio sound system, such as the sound system of the infotainment center.

In one embodiment, shown in FIG. 2, many of the functional aspects of the query processing apparatus components are implemented by a microprocessor 24 that is coupled through suitable bus structure 26 to a non-transitory computer-readable memory 28. If desired, the processor 24 and memory 28 may be coupled to, embedded in or associated with the infotainment center electronics 30. Vehicle position is supplied by GPS navigation system 32 and/or by a cellular locator. In this regard, many GPS navigation systems in popular use today comprise a hybrid system that uses GPS satellite navigation signals in conjunction with locally generated inertial guidance signals from an inertial measurement unite (IMU) 33. In effect, the GPS signals provide vehicle location data in periodic increments and the inertial guidance system uses vehicle speed and accelerometer data to interpolate position between each of the GPS increments by dead reckoning. Cellular location techniques perform vehicle location by triangulating from the position of nearby cellular towers. RF triangulation based on cellular information and WiFi information may also be used for location determination. These different location data may be used separately or in combination to provide up-to-date vehicle location information correlated to the time clock of the query processing apparatus.

The apparatus further includes an input/output circuit 34 to which the internal and external sensors are attached. Thus, as illustrated, the input/output circuit may be supplied with visual data from a camera array 36 comprising one or more cameras pointing outwardly from the vehicle to capture information about conditions external to the vehicle. Gesture sensors 20 and the 3D camera sensor 14 are also connected to the input/output circuitry 34. The apparatus can connect to online databases 37 such as internet databases and services using a wireless connection, which may be connected to or incorporated into the input/output circuitry 34. One or more microphones 22, or a microphone array communicate also with the input/output circuit 34. Internal microphones capture human speech within the vehicle. By arranging the internal microphones in a spaced array, the system can localize the source of speech (who is talking) and filter out noise (beam steering). External microphones can also be included, to capture sounds from outside the vehicle.

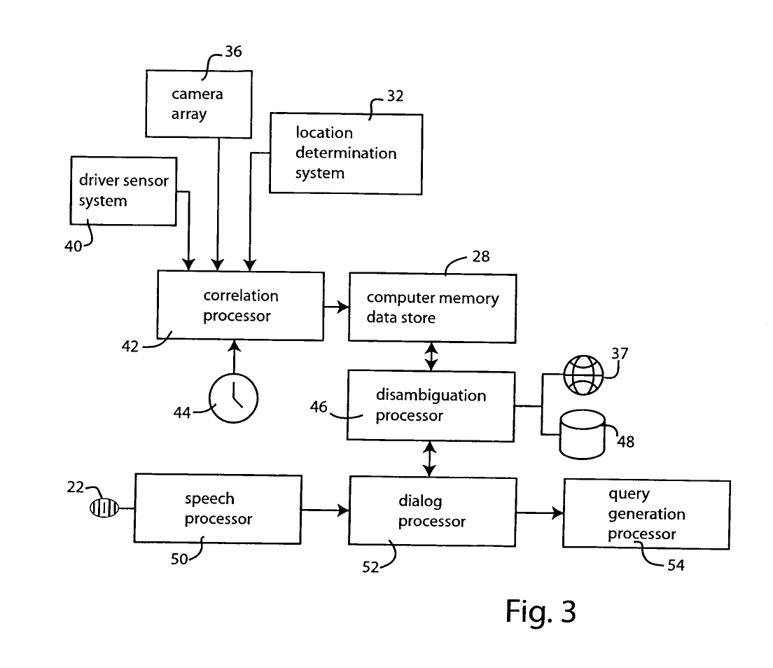

The processor 24 is programmed to execute computer instructions stored within memory 28 to effect various processor functions that will now be described in connection with FIG. 3. The driver sensor system 40, comprising the camera 14 (which may be standard optical camera or optional 3D camera) and gesture sensors 20 (FIG. 2), the camera array 36 and the location determination system, GPS/cellular location 32, all provide data that are mediated by the correlation processor 42. Essentially, the correlation processor, which may be implemented by programming processor 24 (FIG. 2) accesses a system clock 44 to associate time stamp data with the driver activity data received from driver sensor system 40, with the visual data received from camera array 36 and with the location data received from the location determination system 32. The correlation processor stores this time-stamped data in the computer memory data store 28. If desired, the system clock 44 can be synchronized with the GPS system or the cellular telephone system. External microphones, if provided may be used to provide localizing information, such as localizing the source of emergency sirens and their direction.

In the illustrated embodiment, the computer memory data store 28 may include a buffer of suitable size to hold camera array motion picture data for a predetermined interval of time suitable to store events happening external to the vehicle for a brief interval (e.g., 10 seconds) prior to a speech utterance by the driver. In this way, phrases spoken by the driver can be disambiguated based on events the driver may have seen immediately prior to his or her utterance. Of course, a larger buffer can be provided, if desired, to store longer intervals of external event information.

The correlation processor 42, in effect, links or correlates the driver activity data with the visual data and with the vehicle location data. This allows the disambiguation processor 46 to correlate the direction the driver is looking, or gestures the driver has made, with visible objects external to the vehicle and with the vehicle's current location. In this way, when the driver issues an utterance such as, “What is the name of that building?”, the disambiguation processor can ascertain the meaning of “that building” by reference to the direction the driver was looking when making the utterance or from gestural cues received from the gestures center 20 (FIG. 2). The disambiguation process can use location and visual information. For example, the system can extract the picture, obtained from external cameras, of a point of interest (POI) being pointed to by the user, and then compare it to pictures or businesses in the viscinity. Having correlated location information allows the disambiguation processor 46 to associate a geographic location with the disambiguated building (e.g., “that building”). With the location information, the disambiguation processor can then access either a local database 48 or online database or online service 37 to obtain the name or other information describing “that building”.

Like the correlation processor 42, the disambiguation processor 46 may be implemented by programming processor 24 (FIG. 2).

The disambiguation processor 46 works in conjunction with the speech recognition system to assist in extracting meaning from the driver's utterances. Spoken utterances are picked up by microphone 22 and processed by speech processor 50. The speech processor works in conjunction with a dialogue processor 52 to parse phrases uttered by the driver and ascertain their meaning. In a presently preferred embodiment, the speech processor 50 operates using a set of trained hidden Markoff models (HMM), such as a set of speaker independent models. The dialogue processor embeds stored knowledge of grammar rules and operates to map uttered phrases onto a set of predefined query templates. The templates are configured to match the sentence structure of the uttered phrase to one of a set of different query types where information implied by the driver's looking direction or gestural activity are represented as unknowns, to be filled in by the disambiguation processor. Speaker identification from the optical sensor can be used to increase accuracy of the speech recognition and load appropriate profiles in terns of preferences (search history). If a network connection is available, the system can distribute the speech recognition process to processors outside the vehicle via the network.

For example, one dialogue template seeks to ascertain the name of something:
“What is the name of that ______?”

The dialogue processor would parse this phrase and recognize that the placeholder “that ______” corresponds to information that may be potentially supplied by the disambiguation processor.

In a more sophisticated version of the preferred embodiment, the dialogue processor will first attempt to ascertain the meaning of the spoken phrase based on context information (location-based data, vehicle sensor data) and based on previous utterances where possible. As it attempts to extract meaning from the uttered phrase, the dialogue processor generates a likelihood score associated with each different possible meaning that it generates. In cases where the likelihood score is below a predetermined threshold, the dialogue processor can use information from the disambiguation processor to assist in selecting the most likely candidate. Context-based grammar may be used, based on the location and anticipating what the user might say, combined with query history. This will boost query accuracy.

Once the speech recognizer of the dialogue processor has ascertained the meaning of the uttered phrase (e.g., expressed in the SPARQL format), the dialogue processor uses semantic and ontology analysis to match it to a set of predefined available services that can service the query. The dialogue processor thus issues a command to the query generation processor 54 which in turns constructs a computer query suitable for accessing information stored in the local database 48 or obtained from online databases or online services 37. In addition, the query generation processor 54 can also be configured to issue control commands to various electronic components located within the vehicle.

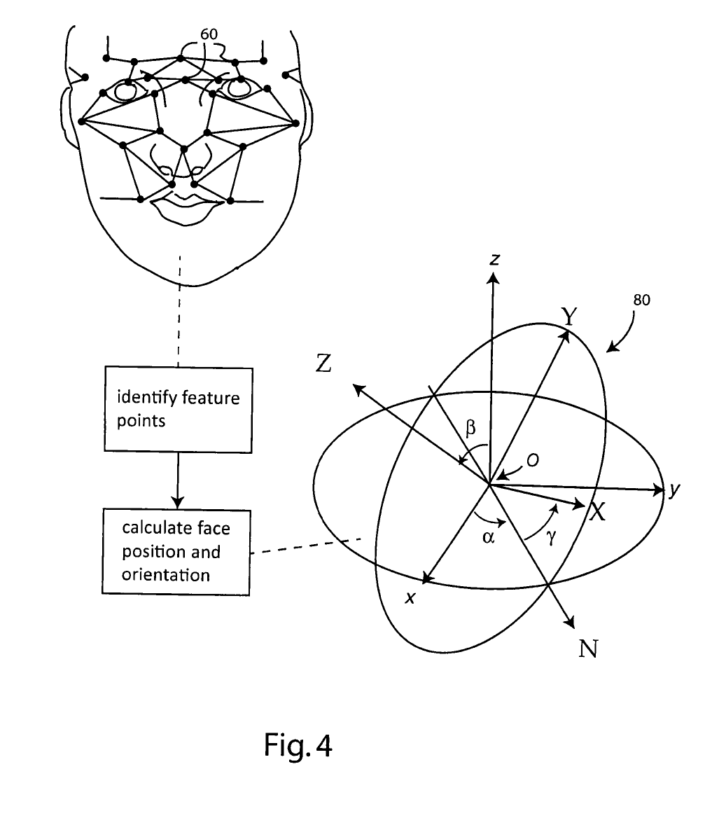

The driver sensor system responsible for determining what direction the driver is looking can operate upon facial information, head location and orientation information, eye movement information and combinations thereof. In one embodiment illustrated in FIG. 4, the driver's face is digitized using data obtained from the camera 14 (FIG. 1) and connected feature points 60 are extracted. If desired, these extracted feature points can be used to perform face recognition by accessing a data store of previously registered faces that are stored within memory 28. Face recognition can be used to preload the driver sensor system with previously learned information about the driver's gestural habits and typical head movement habits. Such face recognition is optional in some embodiments.

The identified feature points are connected by line segments, as illustrated, and the relative positions of these feature points and the respective lengths of the interconnecting line segments provide information about the position and orientation of the driver's head and face. For example, if the driver turns his or her head to look in an upwardly left direction, the position and distances between the feature points will change as seen from the vantage point of the 3D camera 14. This change is used to calculate a face position and orientation as depicted at 80. The algorithm uses the individual feature points to define a surface having a centroid positioned at the Origin of a coordinate system (XYZ) where the surfaces positioned to lie within face coordinate frame (xyz). The angular difference between these respective reference frames has been calculated (αβγ) and the angular direction serves as the facial pointing direction. Preferably, the reference frame XYZ is referenced to the reference frame used by the GPS system. Thus, for illustration purposes, the north vector N has been illustrated to represent the GPS reference frame. In an alternate embodiment, Active Appearance Model (AAM) algorithms can also be used to track the head orientation.

As the driver moves his or her head to look in different directions, the plane defined by the identified feature points will change in orientation and the resulting change, when compared with the reference frame XYZ, serves as a metric indicating the driver's looking direction.

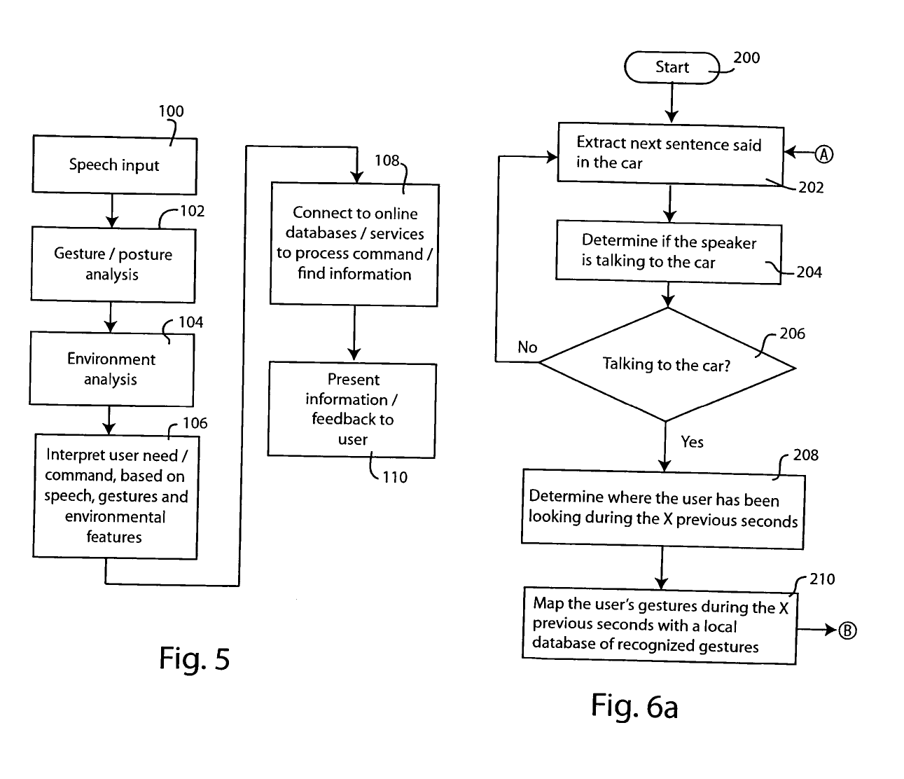

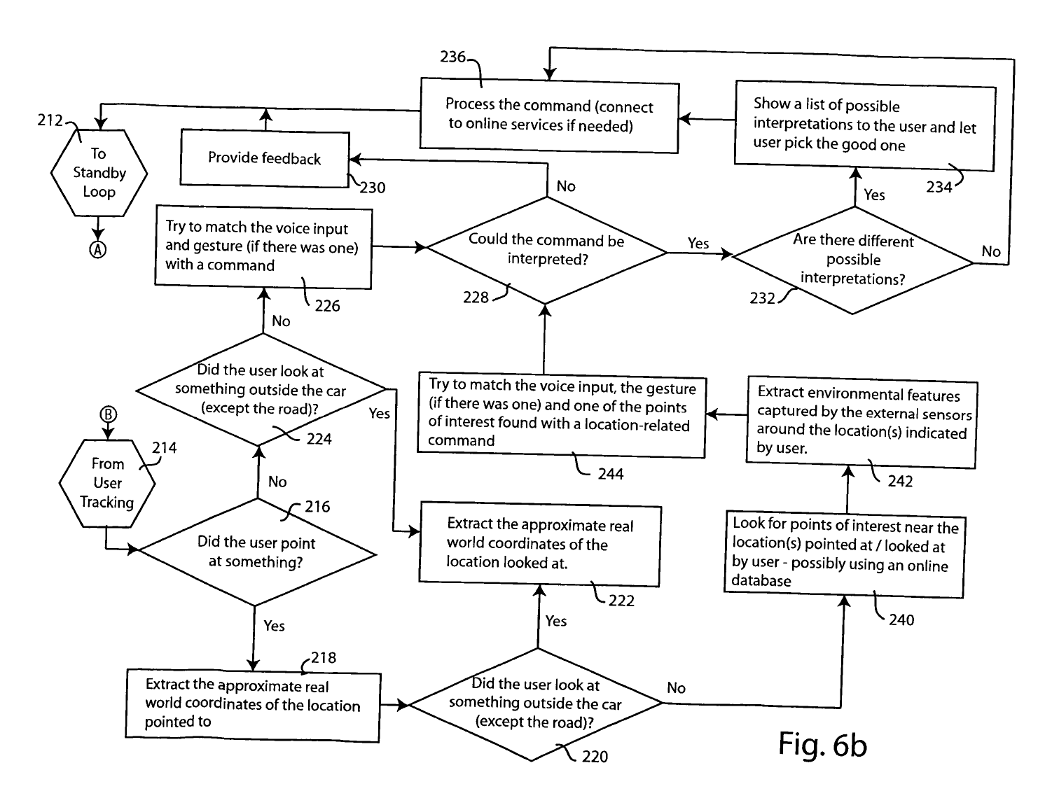

The operation of the natural query processing apparatus and its method of use will now be described with reference to FIGS. 5 and 6a/6b. Referring first to FIG. 5, speech input is processed at 100 by the speech processor 50 (FIG. 3) while gesture and posture analysis is sequentially or concurrently performed at 102. As previously explained in connection with FIG. 3, gesture and posture analysis is performed using the driver sensor system 40, with the data being time-stamped and stored by mediation of the correlation processor 42.

Meanwhile, environment analysis is performed at 104, using the camera array 36. As with the driver sensor system data, the camera array data are also time-stamped and stored under mediation by the correlation processor 42 (FIG. 3). Environmental analysis can be performed concurrently with the gesture and posture analysis, or sequentially. Because the respective data are captured and stored in the computer memory data store 28, these can be correlated based upon the respective time stamps.

Next at 106 the user's speech input is interpreted based on the recognized speech from step 100 and further based on the gesture and posture analysis and environment analysis from steps 102 and 104. Once the meaning of the user's utterance has been determined, the query processing apparatus connects to an online database or service or to a local database to find information based on the user's query or command. Then in step 110 the information is presented to the user or directly used to control electronic components within the vehicle. User information can be supplied visually on the screen of the navigation system 18 or audibly through the infotainment system 30.

FIGS. 6a and 6b provide additional detail on how the dialogue processor performs its function, utilizing services of the disambiguation processor 46 (FIG. 3). In the preferred embodiment, the speech processor performs speech recognition upon utterances and then stores them in a buffer within memory 28 as individual phrases or sentences. Thus, the dialogue processor, beginning at step 200, extracts the next sentence from the buffer at 202 and then performs an initial analysis at 204 to determine if the speaker is talking to the vehicle, as opposed to talking with one of the vehicle occupants. This determination can be made by using certain predefined command words that will place the dialogue system into a command mode where utterances are interpreted being intended for the natural query processing apparatus. If desired, a mode button can be included on the vehicle, such as on the steering wheel. Depressing this button places the natural query processing apparatus in command mode. Alternatively, the dialogue processor can determine if the phrase or sentence is intended as a command or query by determining if it matches any of the pre-stored dialogue templates. If the sentence matches one of the templates, the system assumes that it is intended as a command or query intended for the natural query processing apparatus. Based on the results at step 204, the process flow branches at step 206. If the extracted sentence was not determined to be a command or query, then the process loops back to step 202 where the next sentence is extracted from the buffer. On the other hand, if the processed phrase or sentence is determined to be intended as a command or query, process flow proceeds to step 208 where the computer memory data store 28 (FIG. 3) is accessed to ascertain where the user has been looking during the previous X seconds. Furthermore, at step 210 the user's gestures, if any, made during the previous X seconds are mapped according to a locally stored database of recognized gestures, stored in computer memory data store 28 and processing then proceeds to FIG. 6b.

By way of explanation, when referring to FIG. 6b, steps 202, 204 and 206 of FIG. 6a are referred to in FIG. 6b as the standby loop to 12. Steps 208 and 210 of FIG. 6a are referred to in FIG. 6b as the user tracking routine 214.

With reference to FIG. 6b, beginning at 214, the process flow first branches to step 216 which tests whether the user has pointed at something, based on detection of mapped gestures from step 210. If so, flow proceeds to step 218 where the approximate real world coordinates of the location pointed to are extracted. This is performed using the location data stored in the computer memory data store 28. Then, at step 220 if the user has looked at something outside the vehicle other than the road, flow proceeds to step 222 where the approximate real world coordinates of the location looked at are extracted. Where the user is looking may be ascertained by intersecting the gaze direction and 3D map data. That data includes building models that help compute the intersection with the first source of occlusion.

Step 222 may also be reached, as illustrated in FIG. 6b, if it is determined at step 216 that the user did not point at something. In this case, flow proceeds to step 224 where the user's activity data is tested to determine whether he or she looked at something outside the car except the road. If so, flow proceeds to step 222. Pointing may be determined visually using a depth-sensing look at a pointing finger being raised, or not. Pointing can also be used as controls, to signify commands to perform queries relative to vehicle functions or operations. For example: “How do I control THIS mirror,” where finger pointing designates which mirror is referenced. Pointing can also be sensed and used outside the vehicle. For example: “Is this tire OK?” where finger pointing designates the tire in question

From step 224, if the user did not look at something outside the vehicle (other than the road), the dialogue processor 52 (FIG. 3) tries to match the voice input and gesture (if there was one) with a command. If the command could not be interpreted (step 228), user feedback is provided at 230, requesting the user to supply additional information to disambiguate the command. On the other hand, if the command could be interpreted, flow branches to step 232 where an analysis is performed to determine if there are different possible interpretations. If so, a list of all possible interpretations is provided to the user and the user is allowed to pick the preferred one at step 234. After the user has selected the preferred one, or in the event there were not different possible interpretations (step 232), flow proceeds to step 236 where the command is processed with connections being made to online services if needed. Once processed, flow proceeds back to the standby loop to 12.

Returning focus now to step 220, if the user did not look at something outside the vehicle (except the road), the system at step 240 will look for points of interest near the locations pointed at or looked at by the user, in the past, using online database access if necessary. Then, at step 242 environmental features are extracted from the data captured by the external sensors (e.g., camera array 36). After this is performed at step 242, flow proceeds to step 244 where the dialogue manager tries to match the voice input, the gesture (if there was one), and one of the points of interest found with a location-related command. Once this is accomplished, flow branches to step 228 where further processing proceeds as previously described.

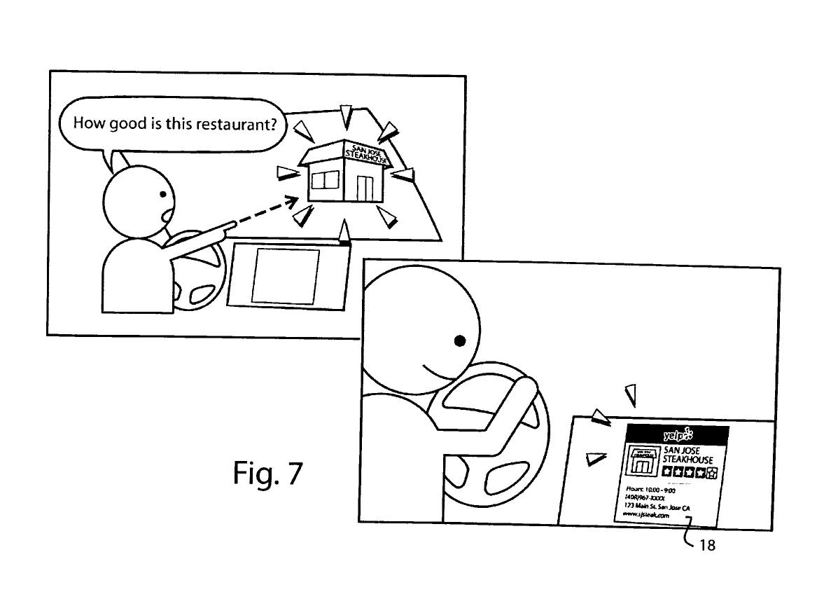

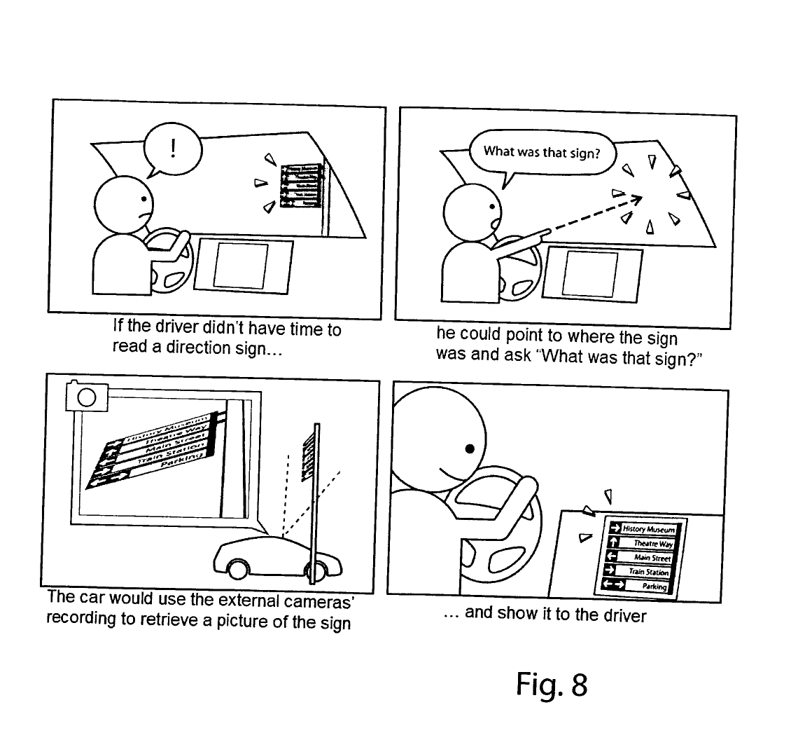

FIGS. 7 and 8 illustrate two exemplary use cases that are made possible by the natural query processing apparatus described herein. In FIG. 7 the user sees a restaurant alongside the road. The user makes a gestural pointing motion at the restaurant and makes the phrase, “How good is this restaurant?” This behavior on the part of the user would place the flow control in FIG. 6b at step 216. The system would therefore look for points of interest (step 240) to ascertain the identity of the restaurant, accessing a map database or online service as needed, and then display the information to the user on the screen of the navigation system. Because the user uttered the question “How good is this restaurant?”, the system would understand that restaurant quality was relevant. Thus, the information extracted from the map database or online resource provides a restaurant quality rating in the displayed information.

FIG. 8 illustrates a use case where the user sees a highway sign but did not have enough time to read it. The user thus utters the question, “What was that sign?” and points where the sign was. Again, because both an utterance and hand gesture were made, flow control in FIG. 6b would again branch to step 216. This time, however, the system would utilize step 242 to extract environmental features, namely, a stored video image of the sign as taken by the camera array 36 (FIG. 2). The information obtained by the external cameras is then either displayed directly on the display of the navigation system, or additional preprocessing may be performed first to map the image into a rectilinear format, making it appear flat and square as if viewed head-on. Additionally, if desired, optical character recognition can be performed on the image to extract textual information from the image and display that textual information on the display screen.

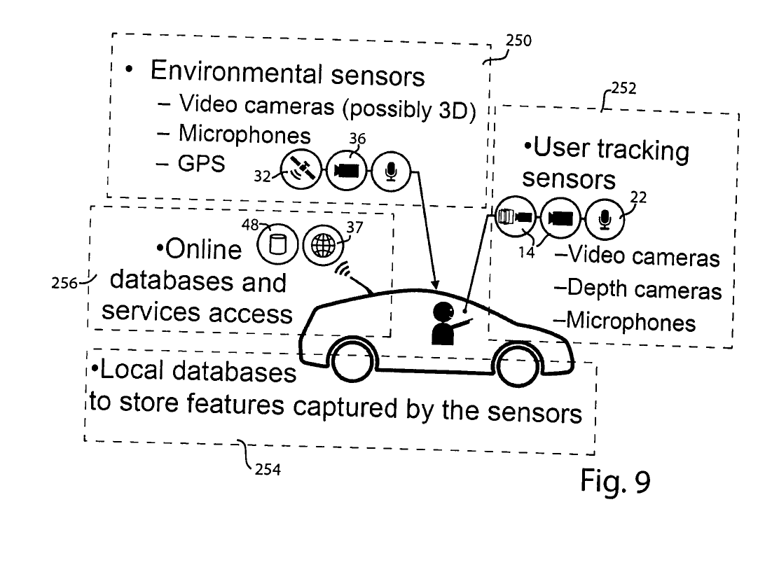

While a number of different possible embodiments are envisioned, FIG. 9 summarizes the basic system components and some of the options for implementing them. As previously described, the apparatus employs environmental sensors (shown collectively at 250). These include video cameras which may be 3D video cameras, microphones and the GPS and/or cellular locator components.

The external camera analyzes the surrounding environment and creates a depth map of the immediate vicinity of the car. It is a 360 3D camera that can be realized using, for instance, stereoscopic or time of flight technologies. Its output is used to segment and parse the environment into several categories of visual information (buildings, vehicles, people, road signs, other signage, etc). The output of the segmentation is stored in a short-term buffer that is mined once the user performs a query. A secondary narrow-angle high-resolution PTZ camera can be used to capture visual information with higher detail when needed and when the direction of interest has been identified.

The external microphone is composed of several sensing units to perform audio source localization and source separation / beam steering. The raw sound input of the different microphone units is recorded in a short-term buffer that is then processed depending on the query issued by the driver, allowing different processing effects to be achieved at query time. For instance, if the driver is asking “What was that sound?”, he is most likely interested in sounds coming out of the car and correlated to vibration patterns coming out of the car. If he is asking “What was that lady shouting?”, the system will first have to identify a high-pitch high-volume human voice in the recordings and then process the various inputs to separate the voice from other sources.

GPS: localization of the vehicle is done using a standard GPS unit in coordination with other sensors, such as compass, accelerometer, gyroscope, altimeter, or full-fledged IMUs in order to increase the localization accuracy. RF triangulation can also be used as an additional source of information.

User tracking sensors (shown collectively at 252) may comprise video cameras, depth cameras and microphones. Video cameras: depth cameras can be used to track the user's head position and record its 6 degrees of freedom, as well as to locate the arms of the driver when he is pointing at a particular direction outside of the cockpit interior. IR cameras can be used to track the user's gaze and identify where the user is looking at. Visible light cameras can be used to identify the user, perform lip/audio synchronization to identify who is speaking, and infer the mood of the user. Visible light cameras are also useful for head position computation and tracking, and for gesture analysis.

Microphone arrays are used to capture the user's voice and identify who is speaking by creating several beams steered at the location of each of the occupants (the position of the mouth can be calculated from the information provided by the depth camera and the visible light camera).

The system is able to access both local databases (shown collectively at 254) and online databases and services (shown collectively at 256). The local databases may be stored within the memory 28 (FIG. 2) of the query processing apparatus, or they may be stored in the other systems located within the vehicle. The online databases and services are accessed by suitable wireless connection to the internet and/or cellular data networks. Online databases will allow the system to retrieve location-based information and general knowledge information to service the queries performed by the user. The database can provide information related to the driving environment (signs, intersections, and so forth), to businesses around the car, and to general information about points of interest in the line of sight. Microphone arrays can be used to determine the origin of the sound and then steer the input towards a particular location.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A natural query processing apparatus for use in a vehicle, comprising:
a driver sensor system disposed inside the vehicle and positioned to monitor physical activity of the driver of the vehicle and to produce driver activity data as a function of time;
a camera system disposed on the vehicle and positioned to collect visual data regarding conditions external to the vehicle as a function of time;
a speech processor that performs speech recognition to convert driver utterances into query data as a function of time;
a correlation processor with non-transitory computer-readable memory that time-correlates and stores said driver activity data, said visual data and said query data;
a disambiguation processor that accesses the computer-readable memory and formulates a computer system query using the stored, time-correlated driver activity data, the visual data and the query data;
the disambiguation processor being operative to ascertain from said stored driver activity data what external condition the driver is referring to during a driver utterance and to formulate the computer system query to correspond to that ascertained external condition.

2. The apparatus of claim 1 wherein said driver sensor system includes at least one camera directed to the driver's face and operative to sense the direction the driver is looking as a function of time.

3. The apparatus of claim 1 wherein said driver sensor system includes at least one camera directed to the driver's face and operative to extract and compare facial features to a set of predefined models to determine the direction the driver is looking as a function of time.

4. The apparatus of claim 1 wherein said driver sensor system includes at least one camera directed to the driver's face and operative to extract and compare facial features to a set of predefined models and thereby determine driver head position and orientation as a function of time.

5. The apparatus of claim 1 wherein said driver sensor system includes at least one camera directed to the driver's eyes and operative to sense the direction the driver is looking as a function of time.

6. The apparatus of claim 1 wherein the driver sensor system includes a gesture sensor responsive to gestural movements of the driver's arms and hands.

7. The apparatus of claim 1 further comprising an information retrieval system receptive of said computer system query that generates a response retrieved from a source of stored information.

8. The apparatus of claim 7 wherein said response is converted into synthesized or digitally reproduced speech and output to the driver via an infotainment system within the vehicle.

9. The apparatus of claim 7 wherein said response is converted into graphical or textual information displayed on a display apparatus located within the vehicle.

10. The apparatus of claim 1 wherein at least two of said speech processor, correlation processor and disambiguation processor are implemented by a single processor preprogrammed to perform multiple tasks.

11. The apparatus of claim 1 further comprising a vehicle location sensor coupled to said correlation processor and operative to provide vehicle location data as a function of time; and
wherein said correlation processor time-correlates and stores said vehicle location data in said memory.
